(19) United States
(12) Patent Application Publication
(10) Pub. No.: US 2017/0005521 A1
(43) Pub. Date: Jan. 5, 2017

(54) CONNECTION TIP AND PROTECTING CASE FOR PORTABLE DEVICE

(71) Applicant: SPS (SUZHOU) INC., Suzhou (CN)

(72) Inventor: Dae Young Youn, Daejeon (KR)

(21) Appl. No.: 15/200,772

(22) Filed: Jul. 1, 2016

(30) Foreign Application Priority Data
Jul. 3, 2015 (KR) 20-2015-0004484

(51) Int. Cl. H02J 50/10; H04B 1/3888; H04B 1/3883; H04M 1/02

(52) U.S. Cl. CPC H02J 50/10; H04M 1/0262; H04M 1/0249; H04M 1/026; H04B 1/3888; H04B 1/3883

(57) ABSTRACT

Provided is a connection tip and a protecting case for a portable device, wherein the protecting case for a portable device includes a case circuit apparatus module in which a circuit apparatus is formed and a protecting case body part, the case circuit apparatus module including a case electrode part, the connection tip including a connection tip connector part and a connection tip electrode part, wherein the connection tip connector part is inserted into and connected to a connection port of the portable device, and the connection tip electrode part contacts the case electrode part when the portable device is inserted into the protecting case in which the connection tip is inserted into the connection port, allowing the portable device to be easily inserted into the protecting case, lowering a production cost of the protecting case, and preventing foreign materials from entering into the connection port of the portable device.

### CROSS-REFERENCE TO RELATED APPLICATIONS

This application claims priority under 35 U.S.C. §119 to Korean Utility Model Application No. 20-2015-0004484, filed on Jul. 03, 2015, in the Korean Intellectual Property Office, the disclosure of which is incorporated herein by reference in its entirety.

### TECHNICAL FIELD

The present disclosure relates to a connection tip and a protecting case for a portable device, and more particularly, to a connection tip and a protecting case for a portable device in which a connector of the protecting case for a portable device is formed using a connection tip separated from the protecting case.

### BACKGROUND

In accordance with the spread of a smart phone, a tablet personal computer (PC), and the like, protecting cases for these portable devices have been mainly used. However, in order to allow these protecting cases to have a function of supplying power through an auxiliary battery embedded therein, a function of wirelessly transmitting power, or the like, as well as a function of simply protecting the portable devices from impact, a separate electronic circuit or electrical circuit (hereinafter, referred to as a ‘circuit apparatus’) has been mainly embedded in the protecting cases. Here, a connector may be provided in the case in order to connect the circuit apparatus and a portable phone in a wired scheme.

An example of the protecting case for a portable device includes a portable phone case.

FIG. 1 is a perspective view of a portable phone case 1 according to the related art. A portable phone 20 may be inserted onto the portable phone case 10 according to the related art. The portable phone case 10 includes a body 12 and a connector 18 protruding from a portion of the body. When the portable phone 20 is inserted onto an upper surface of the portable phone case 10, the connector 18 of the portable phone case 10 may be inserted into a micro universal serial bus (USB) port 28 of the portable phone 20 to connect the portable phone 20 and a circuit apparatus in the body 12 of the portable phone case 10 to each other in a wired scheme. Here, in order to easily insert the connector 18 of the portable phone case 10 into the micro USB port 28 of the portable phone 20, the body 12 of the portable phone case 10 may be made of a material having elasticity so as to be bent to some degrees. However, even though the body 12 of the portable phone case 10 is made of the material having the elasticity, it is not easy to insert the connector 18 of the portable phone case 10 into the micro USB port 28 of the portable phone 20.

In order to solve this problem, in a portable phone case (hereinafter, referred to as a ‘portable phone case 2 according to the related art’) disclosed in U.S. Pat. No. 8,367,235 B2 (registered on Feb. 5, 2013), a body of the portable phone case is formed to be separated.

FIG. 2 is a perspective view of a portable phone case 2 according to the related art. A body of the portable phone case includes a lower body part 14 and an upper body part 16. The lower body part 14 and the upper body part 16 are formed to be detachable from each other. A connector 18 is formed at the lower body part 14. After a portable phone 20 is slid to the lower body part 14 to insert the connector 18 into a micro USB port 28 of the portable phone 20, the upper body part 16 is coupled to the lower body part 14. In the portable phone case 2 according to the related art, although the connector 18 of the portable phone case 10 may be easily inserted into the micro USB port 28 of the portable phone 20, the body of the portable phone case is separated into two parts, such that robustness is low and there is a risk that the upper body part 16 will be lost.

In addition, in the portable phone case according to the related art, kinds of circuit apparatuses formed in the portable phone case are various, and specifications of the connectors 18 that may be inserted into the portable phones are changed depending on kinds of portable phones. However, when various portable phone cases are manufactured depending on the kinds of circuit apparatuses and specifications of the connectors 18, a production cost is increased.

In addition, there is a problem that foreign materials such as water, dust, and the like, may enter the micro USB port 28 of the portable phone.

### SUMMARY

An object of the present disclosure is to allow a portable device to be easily inserted into a protecting case, lower a production cost of the protecting case, and prevent foreign materials from entering into a connection port of the portable device, in the protecting case that may be electrically connected to the portable device through a connector.

In one general aspect, a connection tip and a protecting case for a portable device includes: a connection tip 100 for a portable device coupled to a portable device 300; and a protecting case 200 for a portable device into which the portable device 300 is inserted, wherein the protecting case 200 for a portable device includes a case circuit apparatus module 250 in which a circuit apparatus is formed and a protecting case body part 260, the case circuit apparatus module 250 being provided with a case electrode part 210, the connection tip 100 for a portable device includes a connection tip connector part 120 and a connection tip electrode part 110, the connection tip connector part 120 is inserted into and connected to a connection port of the portable device, and the connection tip electrode part 110 contacts the case electrode part 210 when the portable device 300 is inserted into the protecting case 200 for a portable device in a state in which the connection tip connector part 120 is inserted into the connection port of the portable device 300.

The case circuit apparatus module 250 may include two case electrode part fixing parts 211 and 215, the two case electrode part fixing parts 211 and 215 being formed at both sides of the case electrode part 210, respectively.

When the case circuit apparatus module 250 is coupled to the protecting case body part 260, the circuit apparatus of the case circuit apparatus module 250 may be positioned on a rear surface portion of the protecting case body part 260.

The protecting case 200 for a portable device may further include a protecting case cover part 270, and the case circuit apparatus module 250 may be fixed between the protecting case body part 260 and the protecting case cover part 270.

The connection tip 100 for a portable device may be provided with a waterproof ring 130 enclosing the connection tip connector part 120.

The circuit apparatus may include a battery supporting power to a portable phone in the case in which power of the portable phone is insufficient.

The circuit apparatus may include a power receiving coil for wireless power transmission and a circuit converting a voltage of power absorbed from the power receiving coil into a specific voltage.

The circuit apparatus may include an electrode pattern for a magnetic connector.

### BRIEF DESCRIPTION OF THE DRAWINGS

FIG. 1 is a perspective view of a portable phone case 1 according to the related art.

FIG. 2 is a perspective view of a portable phone case 2 according to the related art.

FIGS. 3A and 3B show a perspective view of a connection tip for a portable device according to an exemplary embodiment of the present disclosure.

FIG. 4 is a perspective view of a protecting case for a portable device according to an exemplary embodiment of the present disclosure.

FIG. 5 is an enlarged view of a case electrode part.

FIG. 6 is a view illustrating a form in which the portable device is inserted into the protecting case for a portable device in a state in which it is coupled to the connection tip for a portable device.

FIG. 7 is an illustrative view of a case circuit apparatus module.

FIG. 8 is an illustrative exploded view of the protecting case for a portable device according to an exemplary embodiment of the present disclosure.

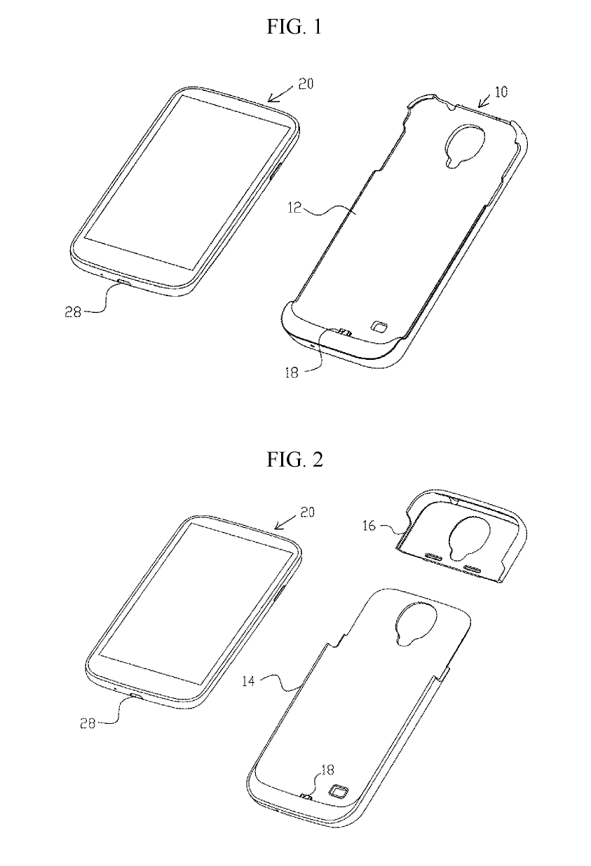

### DETAILED DESCRIPTION OF MAIN ELEMENTS

100: Connection tip for portable device

110: Connection tip electrode part

120: Connection tip connector part

130: Waterproof ring

200: Protecting case for portable device

210: Case electrode part

220: Circuit apparatus

230: Connecting part

231, 235: Case electrode part fixing part

232, 236: Fixing screw

250: Case circuit apparatus module

260: Protecting case body part

270: Protecting case cover part

300: Portable device

### DETAILED DESCRIPTION OF EMBODIMENTS

Hereinafter, a connection tip and a protecting case for a portable device according to an exemplary embodiment of the present disclosure will be described in more detail with reference to the accompanying drawings.

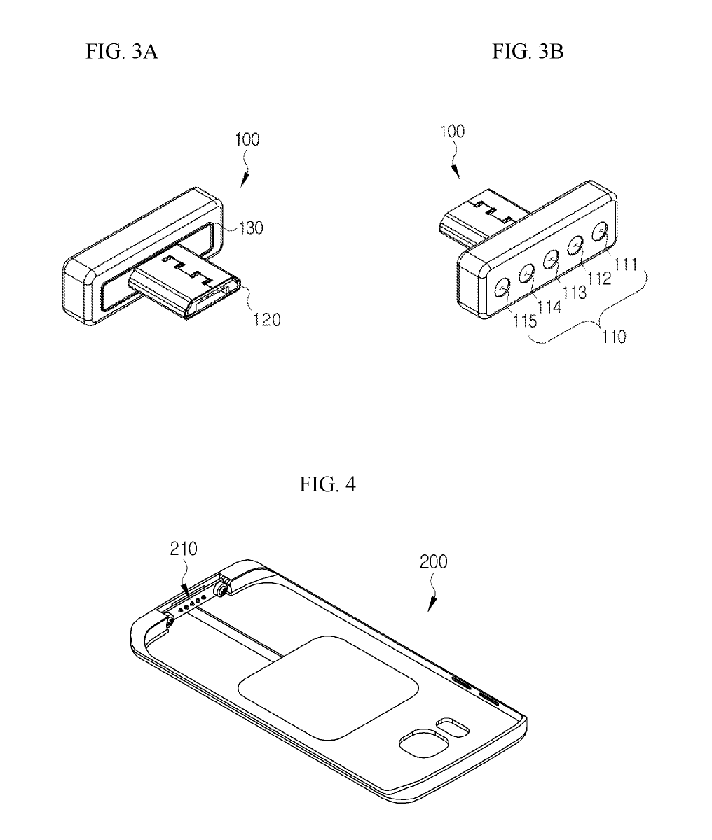

FIGS. 3A and 3B show a perspective view of a connection tip for a portable device according to an exemplary embodiment of the present disclosure. FIG. 3A is a perspective view of the connection tip for a portable device viewed in a direction in which a connection tip connector part may be viewed, and FIG. 3B is a perspective view of the connection tip for a portable device viewed in an opposite direction to the direction of FIG. 3A.

The connection tip 100 for a portable device is provided with a connection tip electrode part 110 and the connection tip connector part 120.

The connection tip connector part 120 is a connector that may be inserted into and connected to a connection port of a portable device (for example, a smart phone), and a micro universal serial bus (USB) connector may be used as the connection tip connector part by way of example. Here, the connection tip connector part 120 may be any connector that may be inserted into and connected to the connection port of the portable device.

A waterproof ring 130 having a form in which it encloses the connection tip connector part 120 is formed in the connection tip 100 for a portable device. The waterproof ring 130, which is to ensure perfect waterproofing so that external water may not enter the connection tip connector part 120 when the connection tip connector part 120 of the connection tip 100 for a portable device is inserted into the connection port (for example, a micro USB port) of the portable device (for example, the smart phone), is preferably made of a soft material. For example, the waterproof ring 130 may be a rubber ring or a silicon ring.

The connection tip electrode part 110 is a terminal electrically connected to the respective terminals of the connection tip connector part 120. Although the connection tip electrode part 110 illustrated in FIG. 3A has five electrodes 111 to 115, the number of electrodes may be changed depending on a demand in a design.

FIG. 4 is a perspective view of a protecting case for a portable device according to an exemplary embodiment of the present disclosure.

A case electrode part 210 is formed at a lower portion of the protecting case 200 for a portable device.

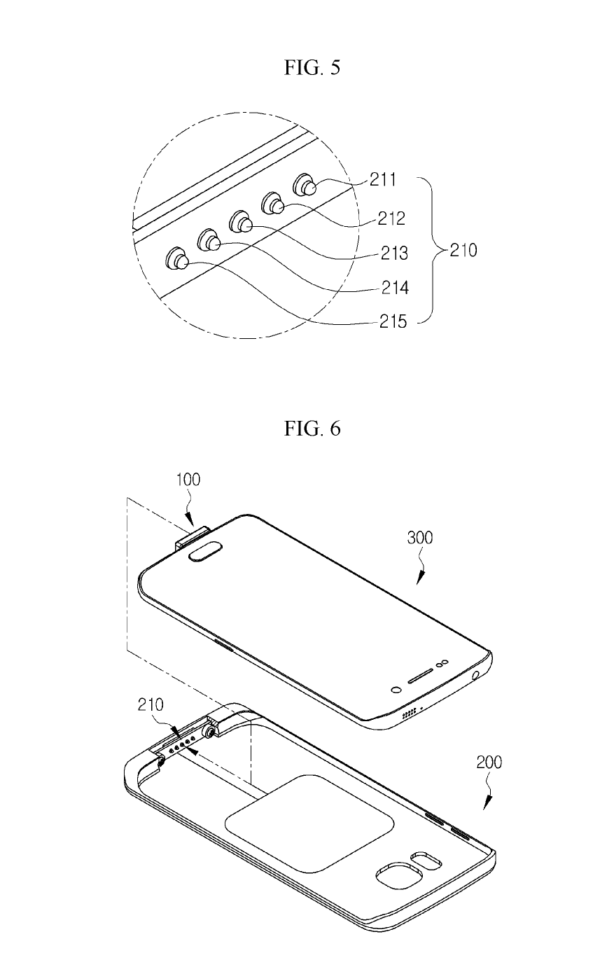

FIG. 5 is an enlarged view of a case electrode part.

Although the case electrode part 210 illustrated in FIG. 5 has five electrodes 211 to 215, the number of electrodes may be changed depending on a demand in a design.

The respective electrodes of the case electrode part 210 are electrically connected to a circuit apparatus in the protecting case 200 for a portable device.

It is preferable that the electrodes 111 to 115 of the connection tip electrode part 110 or the electrodes 211 to 215 of the case electrode part 210 have elastic force in order to allow all of the electrodes 111 to 115 of the connection tip electrode part 110 and the electrodes 211 to 215 of the case electrode part 210 to contact each other well. The five electrodes 211 to 215 illustrated in FIG. 5 may be formed of pogo pins in order to have the elastic force.

Although the electrodes are formed of the pogo pins in order to have the elastic force, the electrodes may also be formed in another form. For example, a leaf spring may be partially exposed to contact an external electrode, and elastic force of the leaf spring may be used to provide the elastic force to the electrode.

It is preferable that pins (for example, pogo pins) having elastic force are formed in the case electrode part 210 in order to allow the connection tip 100 for a portable device to be waterproof. The reason is that an electrode that has the elastic force may easily form a waterproof structure.

FIG. 6 is a view illustrating a form in which the portable device is inserted into the protecting case for a portable device in a state in which it is coupled to the connection tip for a portable device.

As a method of inserting the connection tip connector part 120 into the connection port of the portable device 300 (for example, the smart phone), when the portable device 300 is coupled to the connection tip 100 for a portable device and is then inserted into the protecting case 200 for a portable device, as illustrated in FIG. 6, the connection tip electrode part 110 of the connection tip 100 for a portable device and the case electrode part 210 of the protecting case 200 for a portable device contact each other.

When the connection tip electrode part 110 and the case electrode part 210 contact each other, electricity may flow through five pairs of electrodes contacting each other.

As a result, the portable device 300 is electrically connected to the circuit apparatus in the protecting case 200 for a portable device.

Therefore, in the present disclosure, the portable device may be easily inserted into the protecting case, and it is possible to prevent foreign materials from entering the connection port of the portable device.

A module including the case electrode part 210 may be manufactured in various forms.

This module may include the circuit apparatus in the protecting case or may not include the circuit apparatus in the protecting case.

When this module includes the circuit apparatus in the protecting case, it may be called a case circuit apparatus module.

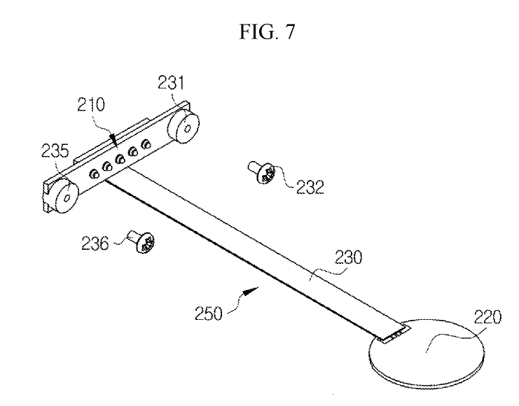

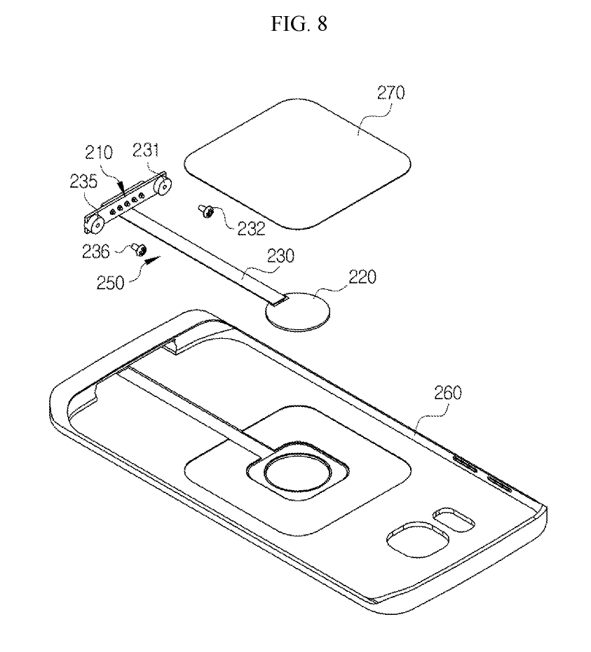

FIG. 7 is an illustrative view of a case circuit apparatus module, and FIG. 8 is an illustrative exploded view of the protecting case for a portable device according to an exemplary embodiment of the present disclosure.

The case circuit apparatus module 250 includes the case electrode part 210, the circuit apparatus 220, and a connecting part 230. The connecting part 230, which is a structure connecting the case electrode part 210 and the circuit apparatus 220 to each other, includes an electric wire installed in order to electrically connect the electrodes of the case electrode part 210 and the circuit apparatus 220 to each other.

The protecting case 200 for a portable device includes the case circuit apparatus module 250, a protecting case body part 260, and a protecting case cover part 270. It is preferable that after the case circuit apparatus module 250 is coupled to the protecting case body part 260, the protecting case cover part 270 covers the case circuit apparatus module 250 above the case circuit apparatus module 250 to fix the case circuit apparatus module 250. That is, it is preferable that the case circuit apparatus module 250 is fixed between the protecting case body part 260 and the protecting case cover part 270.

The protecting case cover part 270 serves to prevent the case circuit apparatus module 250 from being separated from the protecting case body part 260 and prevent the circuit apparatus 220 of the case circuit apparatus module 250 from being exposed to the outside.

In addition, it is preferable that case electrode part fixing parts 231 and 235 are formed at both sides of the case electrode part 210, respectively, to easily fix the case circuit apparatus module 250 to the protecting case body part 260.

Holes are formed in the case electrode part fixing parts 231 and 235, and fixing screws 232 and 236 passing through the holes are coupled to the protecting case body part 260, thereby making it possible to easily fix the case circuit apparatus module 250 to the protecting case body part 260.

Therefore, the case circuit apparatus module 250 includes two case electrode part fixing parts 231 and 235. The two case electrode part fixing parts 231 and 235 may be formed at both sides of the case electrode part 210, respectively.

After the case circuit apparatus module as illustrated in FIG. 7 is produced, when a process of coupling the case circuit apparatus module to the protecting case is performed, production efficiency may be improved.

When the case circuit apparatus module 250 is coupled to the protecting case body part 260, the circuit apparatus 220 of the case circuit apparatus module 250 is positioned on a rear surface portion of the protecting case body part 260. Since the rear surface portion of the protecting case body part 260 is wider than a side surface portion thereof, it is preferable that the circuit apparatus 220 is positioned on the rear surface portion of the protecting case body part 260. The reason is that it is easy to secure a space in which the circuit apparatus 220 of the case circuit apparatus module 250 is to be positioned.

In a protecting case for a portable device according to the related art, kinds of circuit apparatuses formed in the protecting case are various, and specifications of connectors that may be inserted into the portable devices are various depending on kinds of portable devices. On the other hand, in the present disclosure, since the connection tip 100 for a portable device and the protecting case 200 for a portable device may be separately produced, mass production is possible and a production cost may be lowered.

In addition, when the protecting case 200 for a portable device according to an exemplary embodiment of the present disclosure is produced, a process of coupling the case circuit apparatus module 250 including the case electrode part 210 to the protecting case body part 260 is performed after the case circuit apparatus module 250 is produced, thereby making it possible to improve production efficiency.

For example, when it is assumed that kinds of circuit apparatuses formed in the protecting case for a portable device are 10 and kinds of connectors that may be inserted in the portable device are five, in the protecting case for a portable device according to the related art, fifty kinds of protecting cases need to be produced, such that mass-production is difficult. However, when the connection tip 100 for a portable device, the case circuit apparatus module 250, and the protecting case body part 260 are separately produced as in the present disclosure, small kinds of connection tips 100 for a portable device, case circuit apparatus modules 250, and protecting case body parts 260 may be produced, such that mass-production is possible.

There are various examples of the circuit apparatuses in the protecting case 200 for a portable device. The circuit apparatus may include, for example, a battery inserted into a portable phone case and a circuit supplying power of the battery to the portable phone in the case in which power of the portable phone is insufficient. Alternatively, the circuit apparatus may include a power receiving coil for wireless power transmission, and a circuit converting a voltage of power absorbed from the power receiving coil into a specific voltage and supplying the specific voltage to the portable phone. Alternatively, the circuit apparatus may include an electrode pattern for a magnetic connector formed on a surface of the portable phone case, and an electric wire formed in the portable phone case and electrically connecting the micro USB port of the portable phone and the electrode pattern. Here, the ‘electrode pattern for a magnetic connector’ means a structure in which a plurality of electrodes are formed at a portion forming one side connector of the magnetic connector.

Although the protecting case (portable phone case) for a portable phone has been illustrated by way of example in the accompanying drawings of the above exemplary embodiment, the same technology may be applied to a protecting case for a tablet personal computer (PC) in addition to the portable phone, and may also be applied to protecting cases for other portable devices.

In addition, although only a case in which the micro USB port is formed in the portable phone and the micro USB connector is formed in the connection tip for a portable device has been illustrated in the accompanying drawings of the above exemplary embodiment, the same technology may also be applied to a case in which another kind of connection port is formed in the portable device and another kind of connector is formed in the connection tip for a portable device.

In the connection tip and a protecting case for a portable device according to an exemplary embodiment of the present disclosure, it is possible to allow the portable device to be easily inserted into the protecting case, lower a production cost of the protecting case, and prevent foreign materials from entering into the connection port of the portable device.

1. A connection tip and a protecting case for a portable device, comprising:
a connection tip for a portable device coupled to a portable device; and
a protecting case for a portable device inserted into the portable device,
wherein the protecting case for a portable device includes a case circuit apparatus module in which a circuit apparatus is formed and a protecting case body part, the case circuit apparatus module being provided with a case electrode part,
the connection tip for a portable device includes a connection tip connector part and a connection tip electrode part,
the connection tip connector part is inserted into and connected to a connection port of the portable device, and
the connection tip electrode part contacts the case electrode part when the portable device is inserted into the protecting case for a portable device in a state in which the connection tip connector part is inserted into the connection port of the portable device.

2. The connection tip and a protecting case for a portable device of claim 1, wherein the case circuit apparatus module includes two case electrode part fixing parts, the two case electrode part fixing parts being formed at both sides of the case electrode part, respectively.

3. The connection tip and a protecting case for a portable device of claim 1, wherein when the case circuit apparatus module is coupled to the protecting case body part, the circuit apparatus of the case circuit apparatus module is positioned on a rear surface portion of the protecting case body part.

4. The connection tip and a protecting case for a portable device of claim 1, wherein the protecting case for a portable device further includes a protecting case cover part, and the case circuit apparatus module is fixed between the protecting case body part and the protecting case cover part.

5. The connection tip and a protecting case for a portable device of claim 1, wherein the connection tip for a portable device is provided with a waterproof ring enclosing the connection tip connector part.

6. The connection tip and a protecting case for a portable device of claim 1, wherein the circuit apparatus includes a battery supporting power to a portable phone in the case in which power of the portable phone is insufficient.

7. The connection tip and a protecting case for a portable device of claim 1, wherein the circuit apparatus includes a power receiving coil for wireless power transmission and a circuit converting a voltage of power absorbed from the power receiving coil into a specific voltage.

8. The connection tip and a protecting case for a portable device of claim 1, wherein the circuit apparatus includes an electrode pattern for a magnetic connector.
